(19) United States
(12) Patent Application Publication
(10) Pub. No.: US 2003/0182402 A1
(43) Pub. Date: Sep. 25, 2003

(54) Method and apparatus for creating an image production file for a custom imprinted article

(76) Inventors: David John Goodman, Surrey (GB); Donovan Ainsley Kennedy, London (GB)

Correspondence Address: SCHWEGMAN, LUNDBERG, WOESSNER & KLUTH, P.A., P.O. BOX 2938, MINNEAPOLIS, MN, 55402, US

(21) Appl. No.: 10/288,018

(22) Filed: Nov. 5, 2002

(30) Foreign Application Priority Data
Mar. 25, 2002 (GB) 0207016.7
Apr. 24, 2002 (GB) 0209387.0
Jul. 26, 2002 (GB) 0217369.8

(51) Int. Cl. G06F 15/177; G09G 5/00

(52) U.S. Cl. 709/220; 345/716

(57) ABSTRACT

A computer program product creates a production file of an image for application to a custom-imprinted article. The product comprises instructions for displaying at least one web page, down-loading an image, which may be a proxy for a full resolution image, displaying the image in a rendering area of said web page, displaying rendering instruction controls, locally processing the displayed image in accordance with the rendering instructions, and up-loading of the rendering instructions on completion of rendering. The image display instructions provide for displaying a mask in a mask layer and for displaying at least one editable or renderable image in an image layer that underlies the mask layer and appears only through the mask. The images for use with the product including thumbnail images, preview images, proxy images and full resolution images are advantageously provided with a unique identifier within a naming convention established at an image-publishing site.

### CROSS-REFERENCE TO RELATED APPLICATIONS

This application claims priority under 35 U.S.C. 119 from United Kingdom Application No. 0208016.7, filed Mar. 25, 2002; United Kingdom Application No. 0209387.0, filed Apr. 24, 2002; and United Kingdom Application No. 0217369.8, filed Jul. 26, 2002, which applications are incorporated herein by reference.

### FIELD OF THE INVENTION

This invention relates to a method and apparatus for creating an image production file for a custom imprinted article. It also relates to a computer program product for carrying out the method as aforesaid and to digital data in the form of files for low size or resolution images and for web pages containing them, for use in the above method.

### BACKGROUND TO THE INVENTION

Image processing through a network such as the Internet is disclosed in EP-A-0878956 (Canon) whose object is to make it practical to scan in high resolution images of silver-salt photographs e.g. in a server at a print shop, down load the images to a client station, carry out image editing at the client station and up-load editing instructions to the server to enable a rendered version of the high resolution image to be printed at the print shop. For this purpose the print shop scans and stores a high resolution JPEG image at, e.g., 2048×3072 dots per frame, forms a linked JPEG proxy image at a lesser resolution of, e.g., 256×384 dots per frame, optionally forms a thumbnail .gif image at, e.g., 128×192 dots per frame and permits the thumbnail and proxy image to be remotely accessed at the client station for editing or rendering. Upon completion of image rendering on the basis of the proxy image, the client station need only up-load rendering commands to the server at the print shop which can then process the high resolution image using the rendering commands and output a high resolution print of the rendered image through a printer. Downloading of a proxy image and up-loading of rendering commands has the advantage of reducing network information traffic.

Adjustment of image quality to minimise the time required for image download through a network is disclosed in EP-A-0889636 (Fuji).

U.S. Pat. No. 6,281,874 (Sivan et al, assigned to IBM) is also concerned with the problem of downloading graphic images through the Internet. Sivan et al observe that standard technology does not provide a satisfactory solution for the downloading of high quality high resolution graphics images from home pages of originators, e.g., art museums, which involve heavy traffic over the network and high processing power at the client machine. They also observe that although the whole graphics file is downloaded, it is too large to display at the client station where resolution is limited. Even if only a part of the image is displayed, local processing of the entire image by client software is required, which is slow and troublesome. Sivan et al's solution is to provide a method for downloading graphic images from a network server that stores at least one high-resolution graphic image file of a reference image and a corresponding low-resolution graphic image file, the method comprising the steps of: (a) downloading at least part of said low-resolution graphic image file from the network server to a client connected to the network server for displaying a corresponding low-resolution image on a display device at the client; (b) uploading from the client to the network server size data uniquely specifying a portion of the image displayed in (a); (c) extracting said portion of said high resolution graphic image file from the network server to the client; and (d) conforming said portion of the high-resolution graphic image to a display area of the display device for display in said display area thereof. The approach adopted by Sivan et al is of assistance only where the user at the client station does not wish to view the whole image. More significantly, however, many image originators have taken the view that making their graphics files available over the Internet in high resolution involves unacceptable loss of control of potentially valuable copyright material, and this has placed limitations on the potential for exploiting such material.

U.S. Pat. No. 5,838,906 is also concerned with the problem of enabling a user at a small client computer connected to the Internet to locate, retrieve and manipulate data objects such as images when the data objects are bandwidth intensive and computer-intensive. The inventors provide a computer program product for use in a system having at least one client workstation and one network server coupled to said network environment, wherein said network environment is a distributed hypermedia environment. The computer program product comprises a computer usable medium having computer readable program code physically embedded therein, said computer program product further comprising:

computer readable program code for causing said client workstation to execute a browser application to parse a first distributed hypermedia document to identify text formats included in said distributed hypermedia document and to respond to predetermined text formats to initiate processes specified by said text formats; and

computer readable program code for causing said client workstation to utilize said browser to display on said client workstation at least a portion of a first hypermedia document received over said network from said server, wherein the portion of said first distributed hypermedia document includes an embed text format located at a first location in said distributed hypermedia document that specifies the location of at least a portion of an object external to said first distributed hypermedia document,

wherein said object has type information associated with it utilized by said browser to identify and locate an executable application external to the first distributed hypermedia document, and

wherein the embed text format is parsed by said browser to automatically invoke said executable application to execute on said client workstation in order to display said object and enable interactive processing of said object within a display area created at said first location within a portion of said first distributed hypermedia document being displayed in said first browser-controlled window.

The software enables an image to be received at a client workstation, rendering commands to be entered at the client workstation and transmitted to a remote workstation, after which a rendered image is retransmitted to the remote workstation. However, the problem of permitting use and manipulation of the image at the client workstation whilst maintaining security of the image in its high resolution form and preventing the image data downloaded to the client workstation from being freely accessed is not addressed.

Consumer products imprinted with individual customized images or artwork, for example t-shirts, coffee mugs, greetings cards and paper products have become increasingly popular since the 1970's, and the use of computers for the interactive design of the artwork has been disclosed in U.S. Pat. No. 4,873,643 (Powell et al) and is now commonplace.

U.S. Pat. No. 2002/0025085 (Gustafson et al; Ipads.com Inc) discloses a computer-implemented method and system for generating via the Internet articles imprinted with images customized by a user. A web browser at a client station initiates a session with a server system that permits a user at the client station to upload an image to the server or to select an image already available to the server system. The server system provides web pages that permit the user to customize or render a selected image using the editing facilities provided by the ImageEN software available from Hyrix Technologies, SRL. The disclosed functions include adjusting brightness or contrast, image rotation and cropping the image using keystrokes and/or a pointing device to adjust the area and position of what is cropped from the selected image. In particular, cascading style sheets (CSS) and JavaScript/ECMA Script are used to create and position a cropping area within a page having a crop image editing interface in which first and second representations of the image are displayed in respective layers, one layer providing a complete image and the second layer defining the clipped region and a transparent region outside the clipped region. Portions of the image in the first layer coinciding with the clipped region appear highlighted and portions outside the clipped region appear less bright. The clipped region can be dynamically repositioned in real time in response to inputs from the user by redefining the clip properties of the image in the second layer. Facilities are provided for preview of the rendered image, and a subsequent web page enables the rendered image to be displayed on a selected article. The rendered image, which may be post-processed e.g. to convert a file in the PostScript language to raster data for direct use by a production digital printer, is passed to a production system which produces an article or articles having the rendered image applied thereto.

A currently available practical implementation of this technology on the ipads.com website appears to be precisely in accordance with the teaching of the above patent specification. The images on the site are of relatively low resolution, and there appears to be no attempt to maintain image security. Simply right clicking on an image on a downloaded web page displays a menu including a copy facility that enables the image to be copied and pasted e.g. to a Word document where it can be reproduced and transmitted to others at will. nterestingly, Gustafson et al do not consider the advantages of carrying out the rendering operation on the basis of a proxy image of reduced resolution. Furthermore they do not enable the user at the time when he is rendering his image to see how it will appear on the article for which it is intended, which is counter-intuitive and may make it necessary for the user to return repeatedly from the product preview page to the rendering page.

### SUMMARY OF THE INVENTION

The present invention provides a computer program product for use in the creation of a production file of an image for application to a custom imprinted article,

said product comprising instructions for displaying at least one web page, down-loading an image, displaying the image in a rendering area of said web page, displaying in said web page controls for input of rendering instructions, locally processing the displayed image in accordance with the rendering instructions, and up-loading of the rendering instructions on completion of rendering,

wherein said image display instructions provide for displaying a mask in a mask layer and for displaying at least one renderable image in an image layer that underlies the mask layer and appears only through the mask.

The invention also provides apparatus for use in the creation of a production file of an image for application to a custom imprinted article, comprising:

a web server loaded with a computer program product comprising instructions for displaying at least one web page, down-loading an image, displaying the image in a rendering area of said web page, displaying in said web page controls for input of rendering instructions, locally processing the displayed image in accordance with the rendering instructions, and up-loading of the rendering instructions on completion of rendering wherein said image display instructions provide for displaying a mask in a mask layer and for displaying at least one renderable image in an image layer that underlies the mask layer and appears only through the mask; and

means for supplying a rendered image to a printing station.

The invention further provides a method for producing an article having an image applied thereto, which comprises:

storing a full resolution image and a linked proxy image of lower resolution;

downloading from a web server to a client station a web page loaded with the proxy image;

displaying the proxy image in a rendering area of said web page together with controls for input of rendering instructions, said image comprising a mask in a mask layer and at least one renderable image in at least one renderable image layer that underlies the mask layer and appears only through the mask, at least one layer having the proxy image;

locally processing the displayed image in accordance with the rendering instructions;

up-loading of the rendering instructions on completion of rendering; and

printing the resulting rendered image at a printing station on or for application to the article in accordance with the rendering instructions and the full resolution image.

The invention as defined above has the advantage that it focuses on features that are absolutely key to facilitating a user to design his or her own personalized products by giving the user the picture, the product, and in a preferred aspect renderable text together with all the tools and the real time interactive ability to design his or her own finished article. All the processing work is done in real time on the client browser, user transformations being recorded in a series of data fields held as browser session variables. When complete the transformations are uploaded and recorded in a server database. However, the final rendered production file is not transformed until an instruction has been entered for purchase of the product, and this is done as a post-process so as not to affect adversely user response/interactivity. The method of the invention has the advantage of preserving server resources until actually required, and this is a readily scalable process since all the interactivity is done on the client browser. Although initially there is considerable data transfer to the client station, once the image is on the client station, the server is not required to do anything further until image rendering or editing is complete and the design needs to be saved. Even then a database server rather than a web server can perform most of the transformation on the full or high resolution image, so that the performance of the user interaction is maximised.

The present invention also provides a process and apparatus by which a an image at low resolution can be selected at a client station, and the identity of the selected image, preferably with image rendering information entered at the client station, is uploaded to an image publishing station which uses a high resolution graphics file for the image to create an image production file useable by a printing station or other output device.

In a further aspect, the invention provides a method for producing an image production file from data for a high resolution image by remote selection using an image generated using low resolution or reduced size data, said method comprising:

storing images as high resolution graphics files in at least one data storage device accessible to a network;

storing in memory of an image publishing site on the network a unique identifier for each stored image within a naming convention that is common to the images together with the address of the high resolution graphics file for said image, and providing at the image publishing site an image processing program;

providing at websites on the network at locations other than that of the image publishing site web pages including at least one image stored by said at least one image data storage device, formed with reduced size or low resolution image data and associated with the unique identifier for that image;

downloading a web page including at least one said image from one of the websites to a client station on the network remote from the or each image storage means and from the image publishing site and displaying the web page at said client station;

selecting at the client station said image on the displayed web page and entering a processing command that is available if the selected image has an associated unique identifier within the naming convention;

uploading to the image publishing site using an image publishing site location record within the web page the identifier and the command and loading the image processing program using a path and name record within the web page for the image processing program;

extracting from the data storage device data for the high resolution graphics corresponding to the identifier and processing said data at the image publishing site with the processing program to give the image production file for delivery to image application means.

In another aspect, the invention provides apparatus for creating an image production file from data for a high resolution image by remote selection of an image generated using low resolution or reduced size data, said apparatus comprising:

at least one image data storage device accessible to a network for retrievably storing images as high resolution graphics files;

an image publishing site on the network provided with a store for storing a unique identifier for each stored image within a naming convention that is common to the images together with the address of the high resolution graphics file for said image, and also provided with an image data processing program;

one or more websites on the network at locations other than that of the image publishing site for making available at least one web page including at least one image stored by said at least one image data storage device, formed with reduced size or low resolution image data and associated with the unique identifier for that image, the web page having means responsive to selection of the or each low resolution or reduced size image for which an identifier is present to enable input of an image processing command and supply of the network location of the image publishing site and the path to and name of the image data processing program; and

one or more client stations on the network remote from the or each image storage means and from the image publishing site and arranged to permit entry of an image processing command for an image having a unique identifier within the naming convention and contained in a web page received from said one or more websites, and to submit the identifier and the command to the image publishing site so as to cause image data in the high resolution graphics file to be processed at the publishing site with the processing program to create an image production file for delivery to image application means.

The invention also provides a computer program product containing instructions for carrying out the method as aforesaid and a computer readable medium on which such a product is stored e.g. a magnetic or optical disk.

The invention yet further provides a method of forming an image on a substrate which comprises creating an image production file using the apparatus specified above, supplying the image production file to a printer and printing the image contained in said file on a substrate.

It further provides a digital data file for use with the above apparatus, comprising data defining an image at low size or resolution for publication on a web page at a first URL, an identifier for the image, and means providing a link to an image processing program at a second URL with access to a file comprising data defining the image at higher size or resolution.

The ability to test for and select images e.g. thumbnail images in a gallery page by moving a pointer over an image and right clicking the mouse is also advantageous.

In another aspect the invention provides a computer program product for downloading from an image publishing station at a client station and display on a web page of at least one image, a unique identifier within a naming convention being associatable with the image, instructions being provided for testing for the presence of the unique identifier on display of the image and on coincidence of a mouse pointer with the image, and instructions being provided for image reproduction on right clicking the mouse if a unique identifier is associated with the image overlaid by the pointer.

### BRIEF DESCRIPTION OF PREFERRED FEATURES

The computer program product may be supplied as electrical signals through a network such as the Internet, it may be recorded in memory, or it may be recorded on a magnetic or optical disc or other data carrier.

In the above mentioned computer program product, the instructions provide for downloading a mask for entry into the mask layer, said mask corresponding to a product identifier. The provision of a product identifier that enables selection of particular individual products enables a mask to be downloaded to the client station and image editing or rendering to be carried out at the client station using the mask. A single web page may provide both the editable or renderable image and instructions for display of a product selection menu and up-loading of an identifier for a selected product, and this option is preferred because it reduces the operations that have to be carried out at the client station in order to produce the desired edited image. Alternatively the product selection menu and an image editing bay may appear on successive web pages, the instructions providing for downloading a mask corresponding to an identifier up-loaded on selection of a product on a selection menu of a web page preceding said at least one page.

For some products e.g. mobile phones, the mask may have an outline which is an image of the product. Alternatively the mask may have an outline within an outline of the product. The web page may have instructions for down-loading into at least one auxiliary layer an image of the product through which the mask is viewable, said auxiliary layer or layers overlying the mask layer. In this way the user can see at the time when he is editing his image both an image of the product and the image showing through the mask as it will appear on the final product. The auxiliary layers may comprise a first auxiliary layer for receiving a downloaded image of the product, a second auxiliary layer for receiving at least one image of at least one variable region of the product that underlies and appears through the first layer, and wherein instructions are provided for displaying controls for modifying said variable region or regions e.g. to change the color of the variable region or regions.

The instructions advantageously further provide for display in said web at least one web page of at least one control for switching between a first state for entry of local image information and for rendering images entered locally into a first layer and a second state for rendering the down-loaded image in a second layer. Thus the instructions may provide for display on said at least one web page in said first state of a local information entry area and loading into the first layer of information entered in said area. Typically the renderable image in the image layer will be a raster graphics image e.g. a JPEG image.

In order to meet the requirement that even the proxy image is not readily accessible for copying or printing at the client station, the computer program product may further comprise instructions for down-loading the renderable image as a non-editable file compiled for viewing in a player e.g. a .swf Flash Player file. For additional security the .swf file may be compiled with code obfuscation to prevent third party use of a decompiler to inspect ActionScript code and artwork in .swf party files, for example using a program such as ActionScript Obfuscator (Genable Lab) which makes compiled script unintelligible, breaking down decompilers, while still functional with Flash players.

Said at least one web page may display, or is linked to a page displaying, a control linking to one or more pages that permits or permit an image to be up-loaded for rendering and use in the creation of the production file. It may also display, or be linked to a page displaying, a control linking to one or more pages that provide links to one or more browsable galleries each providing one or more pages of images and that contain instructions permitting selection of an image for rendering and use in the creation of the production file. The pages of images may contain instructions for checking the presence of an identifier when a pointer is over the image and on entry of a right click at a pointing device providing an indication whether the image is available for rendering and creation of a production file. Alternatively the at least one web page may display, or be linked to a page displaying, a control linking to one or more pages that permits or permit an image to selected for rendering and use in the creation of the production file on entry of an identifier.

Preferably an image data storage device forms part of the image publishing site. Alternatively, an image data storage device forms part of a website on the network, and the image data processing program includes instructions for uploading a high resolution graphics file from the image data storage device to the image publishing site on receipt from the client station of the identifier for that file and the image processing command.

The image data storage device can conveniently be arranged to store images as JPEG files, or it can be arranged to store images as bitmaps, in which case the image data processing program should include includes instructions for converting a bitmap file to a JPEG file. The image data processing program contains instructions, on receipt of a command that a high resolution graphics file for an image is to be made available, to create at least a second file for the image with low resolution or reduced size data, to allocate a unique identity to the high resolution and to the second file, and to include the unique identity within the second file. The image data processing program may contain instructions for storage of the second file and for downloading the second file for the image to one or more websites on the network for incorporation into web pages e.g. as a thumbnail file.

The image data processing program advantageously further comprises instructions for processing the image data from the high resolution graphics file in response to variables entered at the client station and creating an image production file that contains data for a rendered version of the image. The program may include instructions for creating and downloading to the client station a renderable image data file for the submitted identifier that provides the image at a higher resolution or greater size than the image on the web page, a viewer forming part of a web browser program resident at the client station permitting the image to be rendered with geometrical data entered at the client station, and instructions forming part of the renderable image data file enabling the image identifier and the geometrical data to be submitted to the image publishing site. The instructions may provide for creating a renderable image file having at least first and second data layers, the first layer providing a store for the renderable image data, and the second layer providing a mask through which portions of the renderable image are displayable and that defines an outline for the rendered image. The first layer may store an image as bit map or JPEG data and the second layer may store a product mask as vector graphics, and there may be additional layers e.g. a third layer for text as scaleable font characters. The image data processing program advantageously includes instructions for entering geometrical data selected from the group consisting of X-Y position of the image relative to the mask, angular position of the image relative to the mask, size of the image relative to the mask and image inversion.

### BRIEF DESCRIPTION OF THE DRAWINGS

In order to provide a more detailed explanation of how the invention may be carried out in practice, various preferred embodiments relating to use on the Internet will now be described, by way of example only, with reference to the accompanying drawings, in which:

FIG. 1 shows diagrammatically an image origination station also providing a website, an image publishing station, a client station and an image printing station all connected via the Internet;

FIG. 2 is a block diagram of software resident at the image publishing station including files that are downloadable to and executable at the client station;

FIGS. 3 and 4 are screen dumps of web pages to be produced at a client station by the software of FIG. 2;

FIG. 5 is a block diagram of files for producing an image editing or rendering page;

FIG. 6 shows layers in a Flash movie to be produced on the image editing page;

FIGS. 7 and 8 show the image editing page in a downloaded image rendering state and in a local image rendering state respectively;

FIG. 9 is a diagram showing the principal features of a HTML document stored at the website shown in FIG. 1 and providing for the display of a web page with one or more added images of relatively low size or resolution;

FIG. 10 shows in simplified form a web page as displayed at the client station of FIG. 1 from a HTML document as shown in FIG. 9;

FIG. 11 shows the web page of FIG. 10 after entry of a selected one of a group of displayed low resolution images followed by entry of a request for an a product with a high resolution version of the selected image applied thereto;

FIG. 12 shows possible fields for an originator or content provider record forming part of an originator or content provider database held at the image publishing station of FIG. 1;

FIG. 13 shows possible fields for an image record forming part of an image records database held at the image publishing station of FIG. 1;

FIG. 14 is a flowchart that provides a simplified representation of a sequence of steps to be carried out at the image publishing station on receipt from an originator of a new image; and

FIG. 15 is a flowchart that provides a simplified representation of steps to be carried out by a webmaster at the originator's and/or at a third party website when creating a new web page.

### DETAILED DESCRIPTION OF PREFERRED EMBODIMENTS

Hardware and Image Files

According to the invention, an image publishing station provides an online service enabling customers to download and select images which are subsequently applied to physical products, for example paper sheets e.g. for posters or postcards, covers for mobile phones, mouse mats, mugs, t-shirts, sweatshirts, baseball caps or other clothing or any surface capable of receiving a printed image of the customer's choosing. The publishing station provides the user with three ways of importing images:

upload of images from a client station, e.g. photographs taken by a user;

selection of an image from an existing image gallery page; or

entering a so-called WCP code defining the identity of the image.

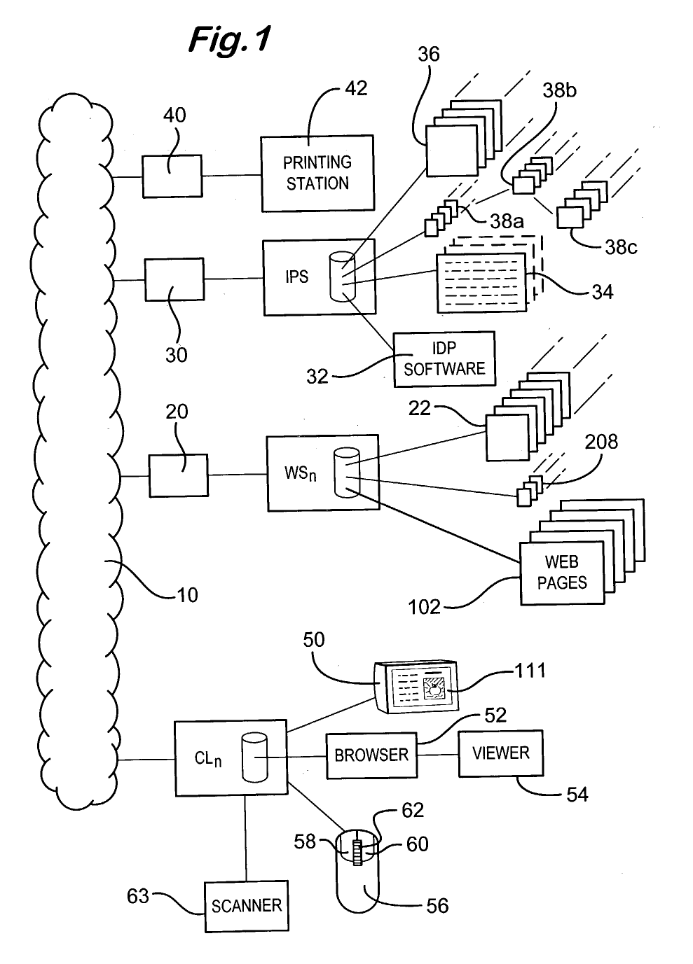

In FIG. 1, a network 10 such as the Internet has connected thereto web server 30 which hosts an image publisher site IPS which typically is stored on a local network including a web server, a database server and a production server and provided with image data processing (IDP) software 32, databases 34 and image files including full resolution files 36 and linked thumbnail files 38a, preview files 38b and proxy image files 38c. Once a full resolution file 36 has been uploaded and the lower versions have been derived, it will be used only for generating image production files, and in particular it will not be made available for download to client stations Clₙ, Only the lower resolution versions are made available for download through the Internet.

Full resolution files 36 may be uploaded to the IPS from client stations Clₙ to permit users to render their own images and have them applied to articles, in which case the IDP software on receipt of an incoming image as a JPEG file automatically processes it to derive linked thumbnail, preview and proxy image files. Typically the thumbnail files 38a are .gif or .jpg files of size 5-10 kb and can provide an array of images on a gallery page for selection at a client station. The preview files 38b are also for display on a gallery page and are .jpg files of somewhat larger size to provide the user on the gallery page with an enhanced view of a an image in which he or she may have indicated an interest e.g. by placing a pointer over the thumbnail image before a definitive image selection is entered. A preview file 38b is, however, smaller than is desirable for use in image rendering, particularly having regard to the need to provide a zoom facility during rendering. For rendering of files to be applied to e.g. articles that may include Al posters, a set of proxy image files 38c is provided at an intermediate resolution. Proxy image file size is generally larger than would be necessary for application to a particular product mask (e.g. a full-size outline of the mobile phone). The image needs to be oversize to permit X-Y rendering of the image with respect to the mask and also of higher definition than required if the image were applied full-size to provide latitude for zooming the image relative to the mask during the rendering process. These files are quicker to upload or download than the full-resolution versions 36, impose less demanding storage and processing requirements at client stations, but nevertheless produce apparently good quality images for rendering purposes on a VDU of a client station.

Full resolution files 36 may also be uploaded from content provider websites WS₁-WSₙ operated by originators of digitized graphics works that are still images. Examples of those who may own or operate content provider websites and who have still images that they wish to make available for reproduction for members of the public on a variety of articles are artists, photographers, individual celebrities, newspapers, magazines, art galleries sporting organizations (e.g. football clubs, golf clubs) and cultural organizations (theatres, orchestras). The images that they have are stored as high-resolution graphics files 22 in bit map form or most usually as JPEG images because digital cameras commonly provide that image format. For application to a small consumer product such as the back face of a mobile phone that typically is of size 45 mm×110 mm, a suitable high resolution file in color is typically 50-200 kb, whereas a file for reproduction as a poster may be of size 2-50 Mb. Such files 22 are generally not made accessible to members of the public in their high-resolution form because content providers fear that once a high-resolution image has been placed on the Internet, control of the image will for practical purposes have been irreversibly surrendered. One of the objects of the invention in a preferred aspect is to provide means that permits remote selection of images in the files 22 and their rendering and subsequent processing for application as high resolution images to selected products without providing the public with working copies of the high resolution images. That object is met according to the invention because the uploaded high-resolution files 36 are not made available over the Internet but only the lower resolution versions 38a-38c. Furthermore, proxy files are only made available as part of a non-editable compiled view-only file, for example a .swf Flash viewer file as also discussed below. Images in such files cannot be copied or printed directly. Holding high-resolution image files 36 at the IPS derived from other content providers WSn is preferred for speed of file access and processing, and to avoid the delay inherent in transmitting full resolution image files through the Internet. However, permanent storage of a high-resolution image file at the IPS is not essential, and for example the thumbnail, preview and proxy image versions could be stored at the IPS with the high resolution version being accessed from the content provider WSₙ only when an image has been rendered and a purchase command has been entered.

As explained above, a proxy image should have the property that it does not permit the image data that it contains to be copied at the client station, and in particular that right click copy function is disabled. An example of a files that have the appropriate properties are Flash movie .gif files created using the Flash program of Macromedia Inc:

(www.macromedia.com/software/flash/productinfo/product_overview/), hereby incorporated by reference.

Such files have a layered structure and can include an image layer in which a proxy file for an image to be rendered is present in bit map or JPEG format, and an overlay layer having a mask having the outline required for reproduction of the image on the selected article. The Flash program prefers to use vector-based content for small file size and fast download, but this may not be appropriate for data in the image layer which will usually relate to photographs, paintings or other still images containing high detail and continuous tones. Converting these images to vector graphics files can give rise to unacceptable loss of detail and tone and can result in vector graphics files which are larger than their bit map or vector graphics counterparts. The mask in the overlay layer will normally be stored as vector graphics. The image layer can be moved relative to the overlay layer for image editing or rendering as described in more detail below.

The services enabled from the image publishing station may provide for online image selection from any web page using an online low resolution or proxy image placed by a web designer on any site from a stock of available images. The client station may be internally ‘connected’ to the IPS website, the user selects the required image and is automatically redirected to the appropriate page of the website, selects an article on which the image is to be rendered and makes payment, e.g., by credit card, or otherwise authorizes the transaction.

A further possibility is to provide on a page of a printed publication an image or gallery of images each having an alphanumeric identifier. When a user has decided that he wishes to purchase an article such as a mug or t-shirt carrying a reproduction of the image, he can use his personal computer Clₙ to communicate with the publishing site IPS, and is provided with means for inputting an identifier for his chosen image and for making payment. The web server IPS will then relay a file containing the selected image to a printing station 42 which will replicate the image on the selected article.

The printing station 42 is connected to the Internet by server 40, and it may be provided with one or more printers for applying graphics images to articles of one or more types directly or via a transfer or in any other suitable way. Although a single printing station 42 is shown, in a practical embodiment, a plurality of printing stations may be associated with an IPS and they may be located, for example, in different regions of a single country or in different countries.

A client station CLₙ is also connected to the Internet and comprises a display 50, one or more web browsers 52 and a viewer 24 together with a mouse 56 or other pointing device provided with left and right buttons 58, 60 and optionally with thumb wheel 62. A scanner 63 enables photographs or other documents to be scanned in at the station Clₙ for up-loading and rendering as required.

Image Production and Rendering Software

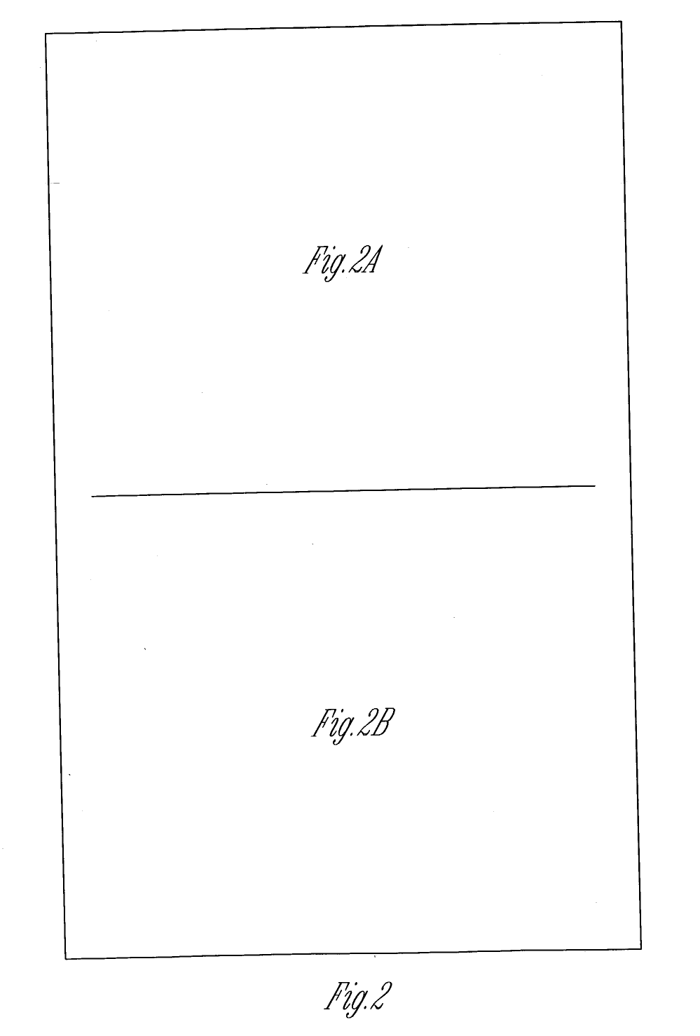

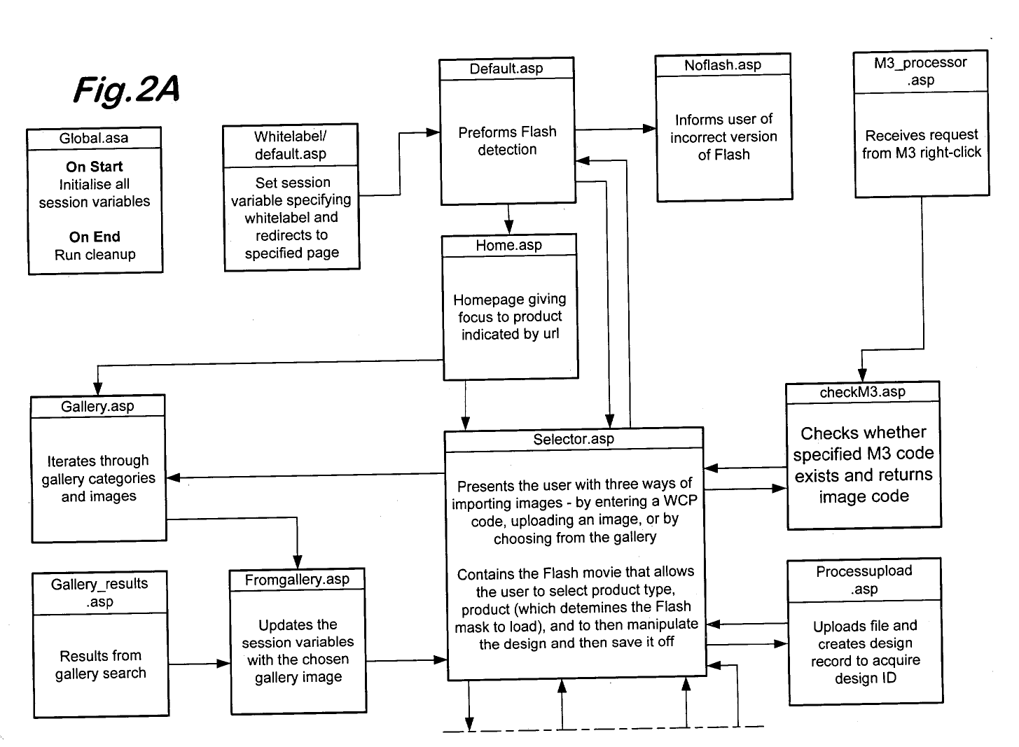

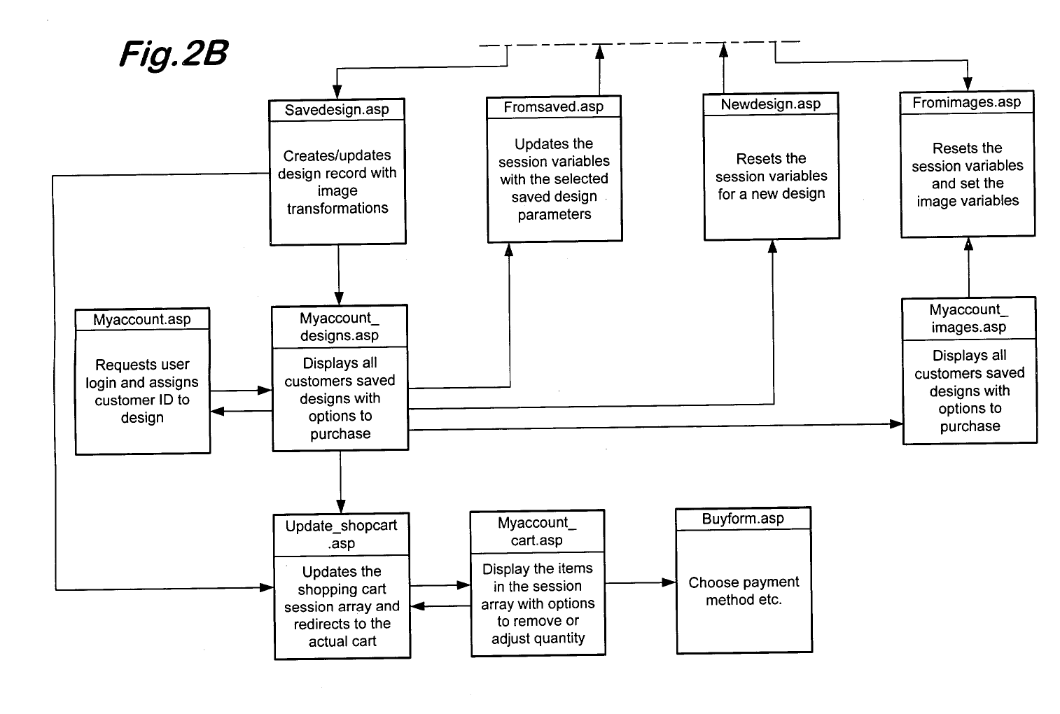

A block diagram showing the main files that make up the IDP software 32 and which are resident on the IPS and downloadable to Clₙ appears in FIG. 2. The file Global.asa executes at start-up and initializes all system variables; at the end of a session it run clean-up. Another housekeeping file Whitelabel/default.asp can be used to customize the software for a particular IPS or content provider WSₙ where it is to be resident, sets session variables for the artwork and logos to be displayed on the pages of the Whitelabel website and redirects to a specified page e.g. a home page for the Whitelabel website. At the home page, the first file to be downloaded to Clₙ is Default.asp which checks for a correct flash reader at Clₙ, and if that reader is not detected executes Noflash.asp which informs the user and provides an opportunity to download a correct version of the flash reader. On detection of a correct reader, Home.asp executes and provides an image selection facility.

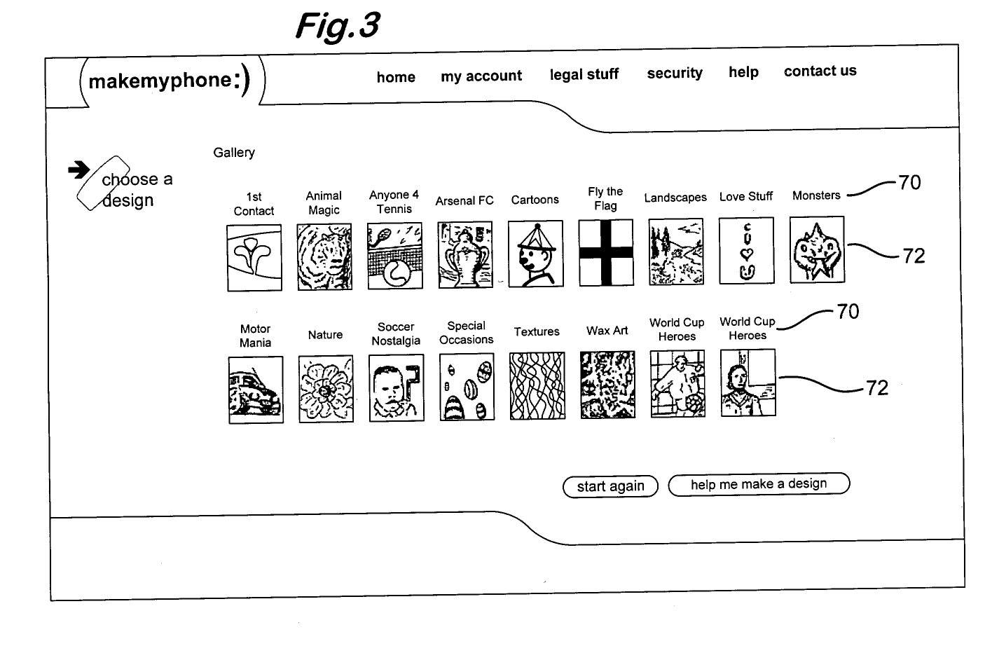

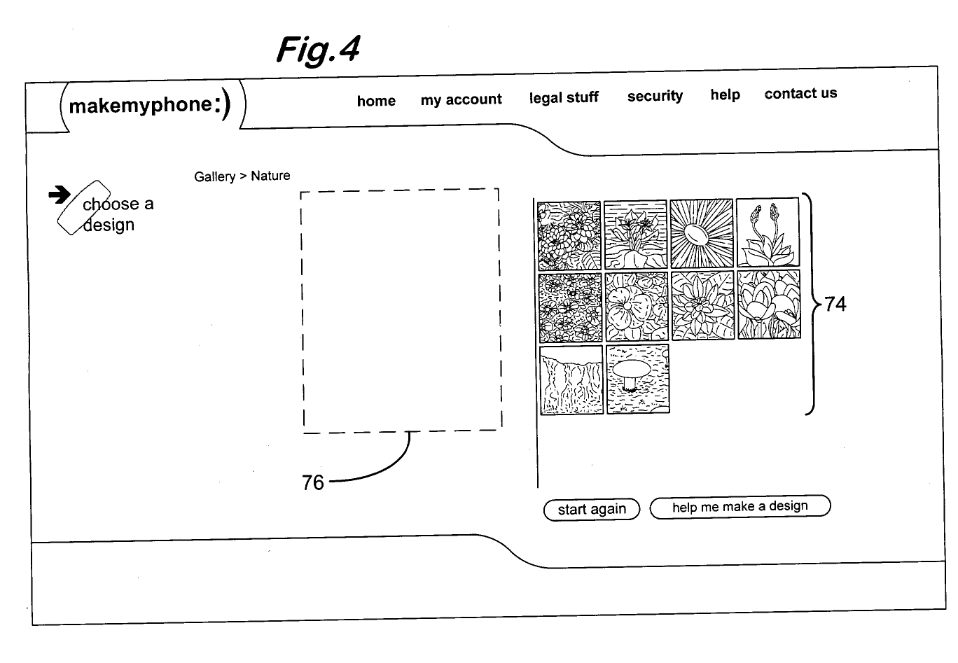

Selection of a browse galleries option causes Gallery.asp to be downloaded and executed. The resulting web page that is displayed at Clₙ is shown in FIG. 3 and provides an array 70 of gallery category titles and an array 72 of thumbnail images derived from the database 38a and representative of the content of each category. Selection by clicking a mouse over any of the images in the array 72 causes execution of Gallery_results.asp which displays a web page at Cln as shown in FIG. 4 that provides an array 74 of thumbnail images also derived from the database 38a. Rolling the mouse pointer over any image in the array 74 causes a linked image from preview file database 38b to appear at display window 76; clicking on the thumbnail image enters a selection. The selected gallery and image are supplied to Fromgallery.asp which updates the session variables with the selected gallery image and causes selector.asp to be downloaded to Clₙ

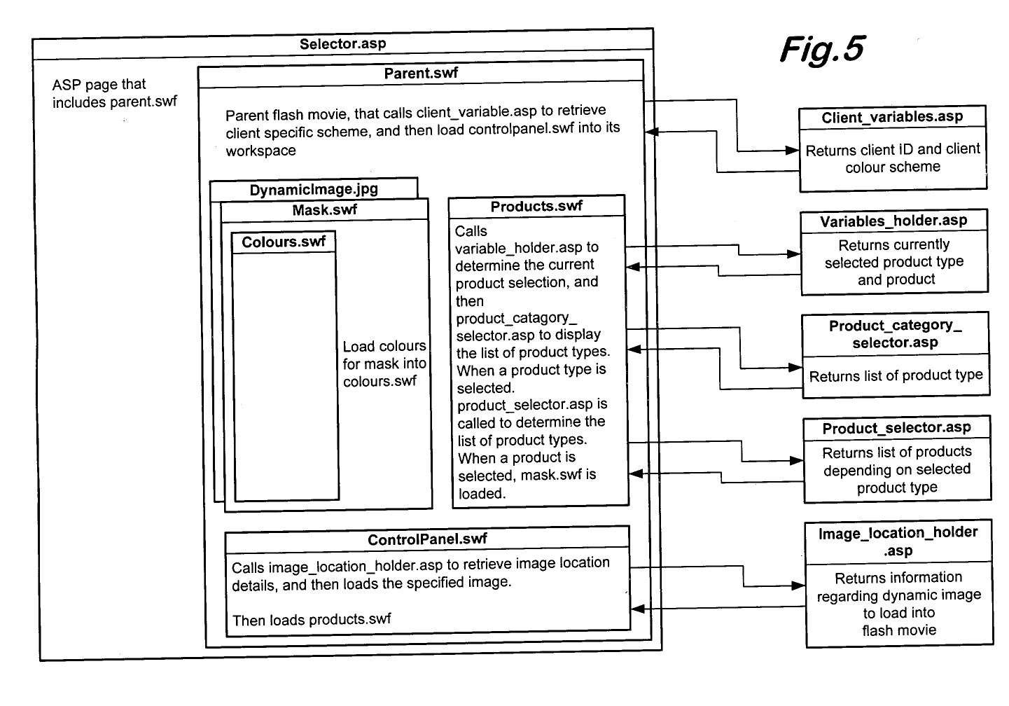

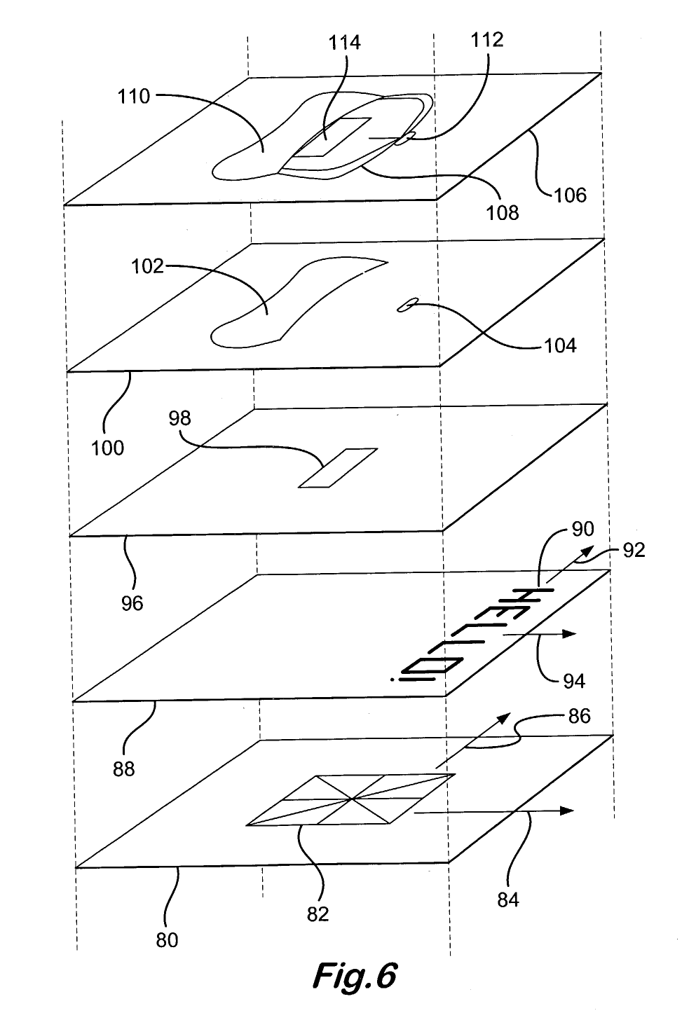

The file structure of Selector.asp is shown in FIG. 5 and the significant parts of the resulting web page displayed at Clₙ appear in FIG. 6 which shows the page in an edit image mode. Execution of Selector.asp calls a Flash movie Parent.swf which in turn calls client_variables.asp to retrieve a client specific color scheme and load ControlPanelswf into its workspace. Execution of ControlPanel.swf causes image_location_holder.asp to retrieve location details for the image defined by the session variables updated by Fromgallery.asp and load the specified image from proxy image database 38c into DynamicImage.jpg, followed by Flash movie Mask swf for the selected product and Colours.swf which loads colors for the mask. ControlPanel.swf then calls Products.swf. That file in turn calls Variables_holder.asp which returns a currently selected product type and product and provides a default product for display in a rendering region of the web page, Product_category_selector.asp which displays a list of product types and Product_selector.asp which returns a list of products depending on the selected product type. When a product is selected, mask.swf is loaded followed by colors.swf into which colors for colored regions of the mask can be loaded.

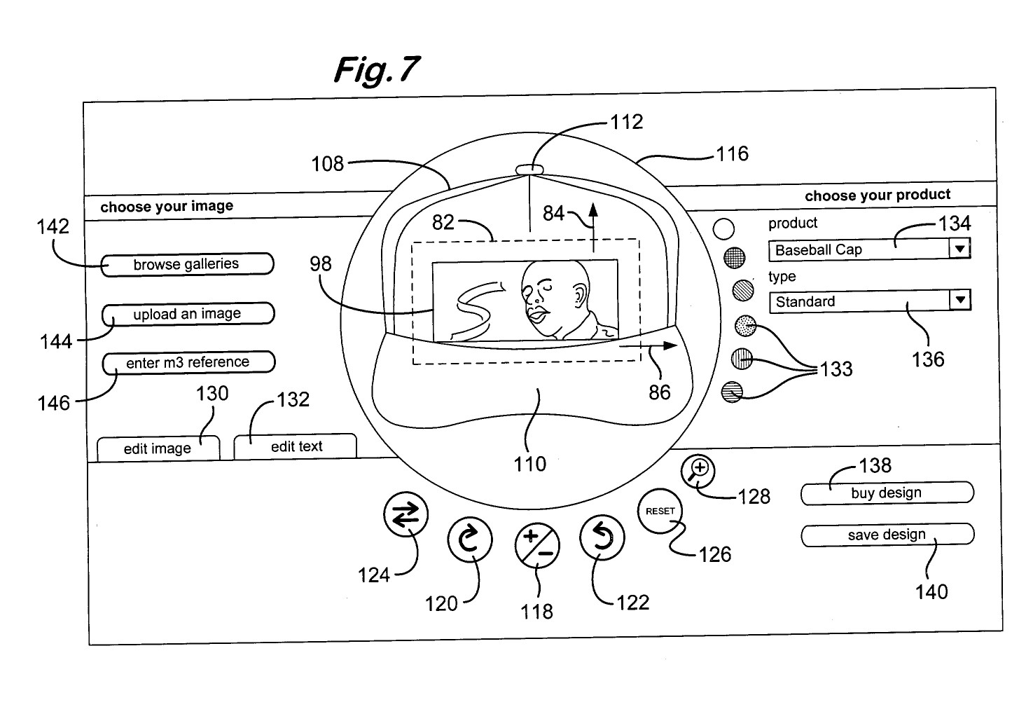

The various Flash movies and files called by selector.asp cause a layered image to be displayed in design bay 116 of an image rendering web page the most significant portions of which appear in FIG. 7. An image-receiving layer 80 is loaded with the file in DynamicImage.jpg from image database 38c to create proxy image 82 which can be moved omni-directionally by dragging with a mouse as indicated by arrows 84, 86. The image in layer 80 will normally be derived from a photograph and is therefore advantageously stored in raster graphic form. The current version of Flash (Flash MX) allows dynamic insertion of JPEG images, which avoids the need to use third party tools to achieve this objective. An overlying layer 88 for text and other image information entered locally at Clₙ contains an image 90 that is also movable omni-directionally by dragging with the mouse as indicated by arrows 92, 94. The layer 88 is otherwise transparent. The stored information may conveniently be in the form of vector graphics. A mask layer 96, again conveniently in vector graphics is created by mask.swf and has a mask opening 98, portions of the layers 80 and 88 being displayed only when they fall within the outline of the mask opening 98, and the mouse only effecting movement of an image in layer 80 or 88 when the mouse pointer falls within the outline of the mask opening 98. The mask opening outline may coincide with the product outline e.g. when the image to be rendered is to be applied to the rear face of a mobile phone, but in the case of other products e.g. the illustrated baseball cap it falls within the outline of the product. Two auxiliary layers overlie the mask layer 96. A layer 100 provides for creation of variable regions 102, 104 of the product and these underlie corresponding regions 110, 112 of product image 108 in a second auxiliary layer 106.

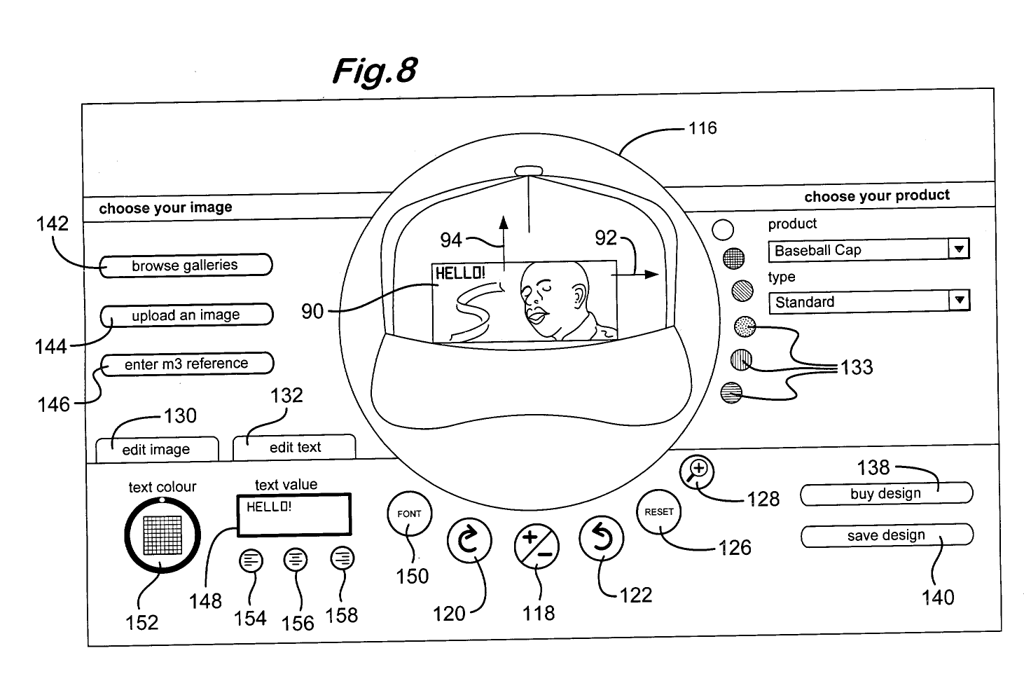

The appearance of the most significant portions of the resulting web page is shown in FIG. 7. In addition to the design bay 116, the file ControlPanel.swf displays rendering control buttons operatively linked to the images on layers 80, 96. These include zoom control 118, image rotate controls 120, 122, mirror invert key 124, reset key 126 and magnifier key 128. The latter control is especially useful for rendering the image to be applied to e.g. a product such as a jigsaw where close inspection is needed when positioning the image 82 in relation to cut lines for the jigsaw that are displayed as part of the mask. It will be observed that the size of the image 82 is greater than that of the mask opening 98. Controls 130, 132 toggle the web page between the image rendering state of FIG. 7 and a text or local input rendering state shown in FIG. 8. Color selection controls 133 enable a selected color to be applied to variable regions 110, 112 of the product. A pull-down product category menu 134 and a pull-down product type menu 136 are displayed under the control of files Product_category_selector.asp and Product_selector.asp.

On completion of the rendering operation, a purchase decision can be entered by selecting control button 138 and a save design decision can be entered by selecting save design button 140. In either case Processupload.asp (FIG. 2) provides for entry at Clₙ of an identity for the newly created rendered design and upload of the image and product identifiers together with the rendering information to the IPS. If the user wishes to try an alternative image, selection of browse galleries button 142 passes control to Gallery.asp and return to the display of FIG. 3. Operation of button 144 enables a user to upload one or more locally generated images, which may be made available for display and processing in additional gallery pages like FIGS. 3 and 4. Such uploaded images may be images derived from a camera of a mobile phone or similar mobile device on a switched network and having a built-in camera. Operation of control 146 enables a reference for a particular image to be entered by an alphanumeric code, the reference appearing in versions of an image published on a third party web page with the identifier or published in a publication e.g. a magazine or program for a sporting event together with the alphanumeric identifier.

Selection of the text edit control 132 modifies the web page to the state shown in FIG. 8. A text entry box 148 when selected enables text to be entered and to appear as text image 90 in renderable layer 88. The text is preferably in the form of scaleable font, which is normally provided by vector graphics compatible with Flash. The button 124 is replaced by font selector button 150, a text color selection control 152 is provided and text left, center and text right buttons 154, 156 and 158 can be provided. Entry of local graphics by pasting into area 148 may also be supported, for example banners and other graphics artefacts provided by word-processing and desk-top publishing software.

On completion of an image selection and editing or rendering session and on entry of a product ID using Processuploadasp, Selector.asp calls Savedesign.asp to create or update a design record at the IPS. If a purchase decision has been entered, Update_shopcart.asp updates a shopping cart session array and redirects to the actual cart, Myaccount_cart.asp displays the item or items in the session with options to remove or adjust quality and Byform.asp provides for selection of payment method and other transaction handling and recording procedures. A client station can access a page generated by Myaccount.asp to provide a login facility at the IPS and to assign a customer ID to designs. If an immediate purchase decision is not entered, then entry of a save design command at button 140 saves the design at the IPS for subsequent access using Myaccount_designs.asp which can call Fromsaved.asp to update the editing session variables with the selected saved design parameters and return on the basis of those parameters to Selector.asp. it is therefore possible at Cln to review and re-edit an image edited in an earlier session. Alternatively, Myaccount_designs.asp can call Newdesign.asp to reset the session variables for a new design. In a further alternative, Myaccount_images.asp can displays all of a customer's saved designs with an option to purchase and can call Fromimages.asp to reset the session variables and set the image variables to provide a review facility.

Providing Image Identifiers and a “Right Click” Selection Facility

In a preferred embodiment, the invention provides apparently seamless integration between a third party website WSₙ and the image publisher's website IPS. For this to happen, the image displayed at the third party website must be identifiable by the IPS website when the client station is redirected to the IPS website. One of the objects of the invention is to enable this with minimal intervention by third party web site or web page designers.

To achieve this result, all files 36 and 38a-38c for an image are preferably coded with a serial number unique for the image The third party designer can, for example use the serial number as a unique reference name placed on the page, or the images can be renamed and a publisher's (M3) reference tag can be used. In addition the web designer should include a JavaScript reference at the top of the page. The JavaScript source for this reference will reside on the IPS in an obfuscated form. When a user clicks on the image, a menu is displayed and a redirect function (M3_redirect) is called.

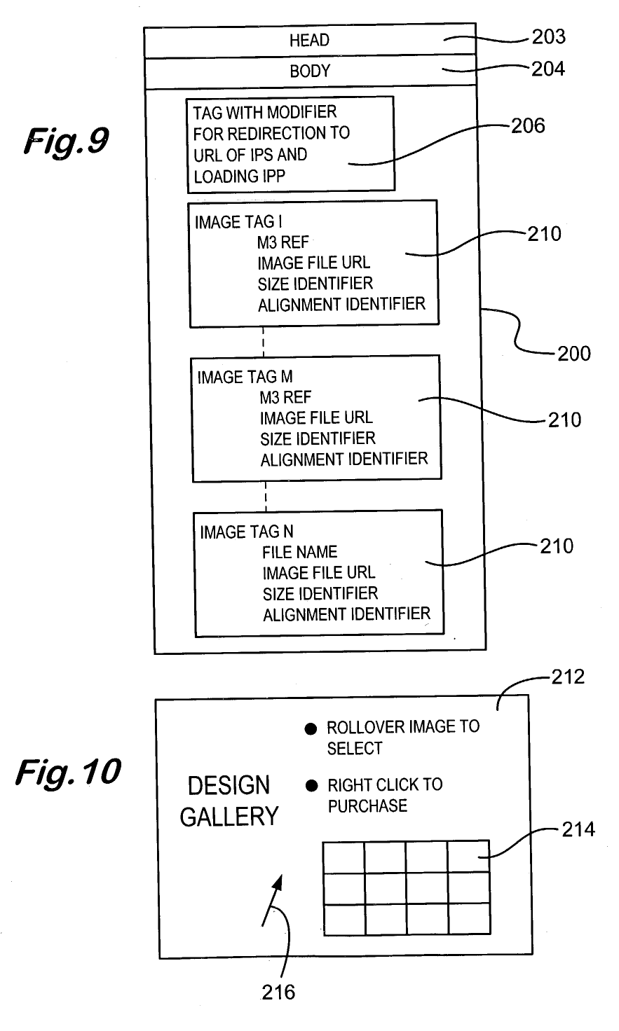

FIG. 9 shows in simplified form a html document 200 for providing an image-containing web page 201 at WSₙ (FIG. 1). It contains a header 202 and a body 204 having at tag 206 containing code for redirection of CLₙ from WSₙ to the IPS and loading of at least one file of the IDP software 32. Such a tag may have the form:

<src=http://[URL]/directory/program file>

A database of low resolution images 208, e.g., thumbnails distributed by the IPS is stored at WSₙ and the HTML document enables one or more of these images from database 208 to be displayed as part of a web page (e.g. gallery page) by the incorporation of image tags 210. Thus a gallery page may contain both thumbnail images downloaded from the publishing station IPS and which contain image identifiers supplied from the IPS and other thumbnail images that have come from other sources and which do not contain such identifiers. In one embodiment, where there is a publisher's reference, the image tag may include the publisher's reference separately or as the file name, and so be of the form:

<IMG SRC=“[file name].gif” m3reference=“[publisher's reference]” WIDTH=142 HEIGHT=106 BORDER=0> or

<IMG SRC=“[publisher's reference].gif” WIDTH=142 HEIGHT=106 BORDER=0>

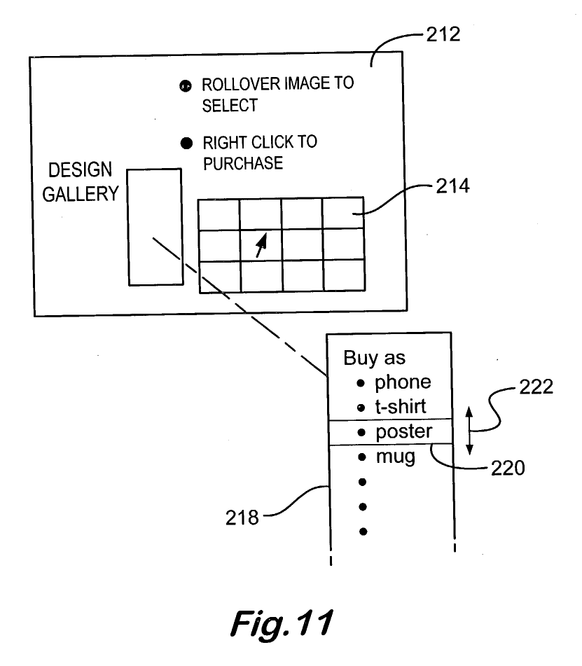

FIG. 10 shows the appearance of the resulting web page 212 when downloaded at CLₙ and displayed on the display 50. The page includes an array or gallery of thumbnail images 214 individually selectable by moving pointer 216 over the selected image and right clicking using key 60 of mouse or other pointing device 56 to enter a selection. As is shown in FIG. 11, this calls up a menu 218 of articles on which the image is available for reproduction. Selection at CLₙ is by scrolling selection bar 220 up or down using direction keys as indicated by arrow 222 and then left clicking on mouse or pointing device key 58. In a variant where product selection is enabled after image selection, right clicking mouse key 60 can provide a link direct to the image rendering screen of FIG. 7 and the article selection can be entered using pull-down menus 134, 136.

The latter variant is illustrated in FIG. 2, where right clicking at the client station calls file M3_processor.asp which receives a request from right click, calls checkM3.asp to check whether a specified M3 code exists in the thumbnail or other image and if so returns the image code which is supplied to Selector.asp which then produces at Clₙ a web page having the features of FIG. 7.

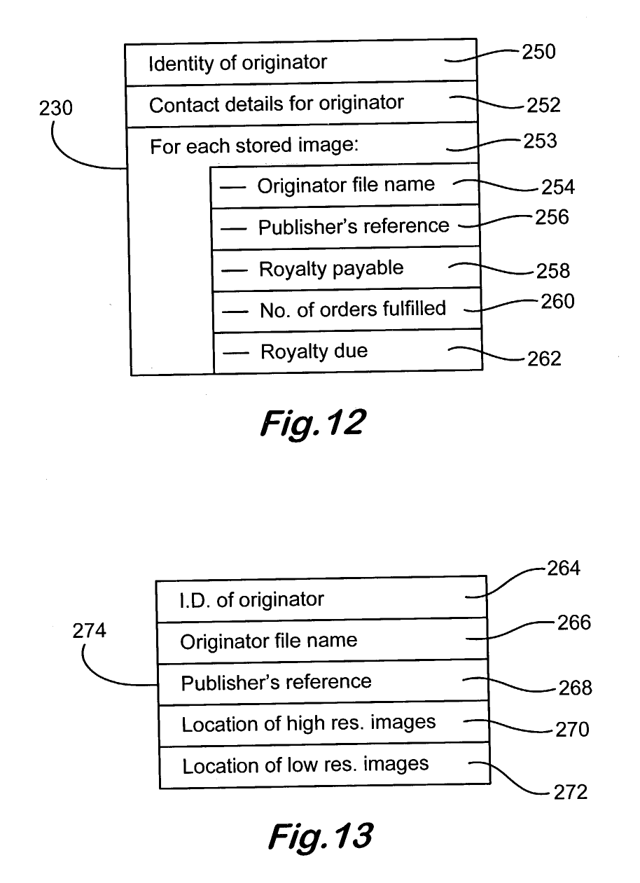

To handle the images supplied to or made available from the IPS, an originator or content provider database 230 is required and a simplified record structure is shown in FIG. 12. It provides an originator or content provider identity field 250, an originator contact details field 252 and fields 253 for each stored image. The fields 253 may be divided into sub-fields for an originator file name 254, a publisher's reference (Ms reference) 256, royalty payable 258, number of orders fulfilled 260 and royalties due 262. Also required is an image database 74 for which a simplified record structure is shown in FIG. 13. Fields are provided for the identity of the originator 264, the originator file name 266, the publisher's reference 268 which links the full resolution image in database 36 and the various derived images in databases 38a-38c, the location of the high resolution image file 270 in database 36 and the locations of the corresponding low resolution image files 272 in databases 38a-38c. It will be appreciated that there are many possibilities for organizing the databases 230, 274 depending upon the requirements of a particular IPS site, and the databases 230, 274 need not be separate but can be parts or layers of a single database.

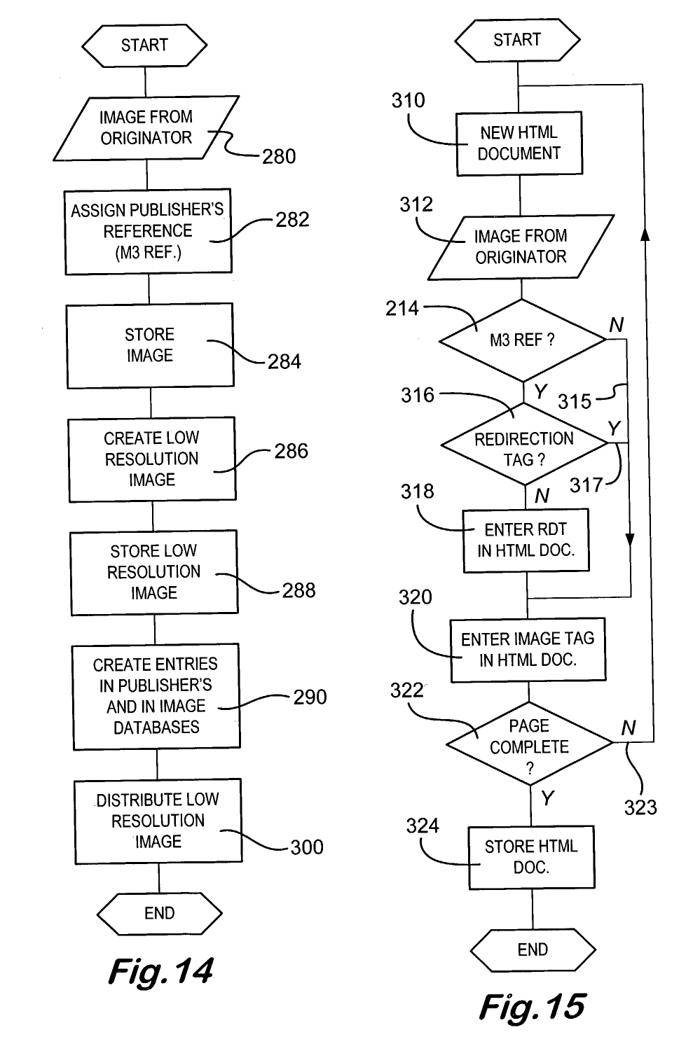

The IDP software, as previously explained, is required to have a routine for receiving high-resolution files from image originators. If the image is not already in JPEG form, it is at present preferred to convert it e.g. from bit map to JPEG for compatibility with the Flash program which is set up to receive high resolution images as JPEG files. The incoming high resolution image 280 (FIG. 14) is allocated at 282 a publisher's or M3 identity within a naming convention which is common to the images after which it is stored at 283 within the disk storage of the server 30 on which the IPS is found. Low size or resolution files including a thumbnail file and a proxy file for the same image and with the same identity are created at 286 and stored at 288 within the disk storage of the server 30. Entries for the image are created in the publisher's and in the image databases at 290, after which the low resolution images can be distributed at 300. The IDP software may contain instructions to return the thumbnail image file automatically to the originating site WSₙ, and to distribute it automatically also to a predetermined selection of other interested websites for incorporation into web pages e.g. gallery pages.

A routine for creation of web pages containing individual thumbnail or preview images other relatively low resolution images, or containing arrays of the thumbnail or other low resolution images, is shown in FIG. 15. The routine creates a new HTML document for a web page at 310, fetches an e.g. manually selected low resolution image 312 from database 208 (FIG. 1) and checks the image file at 314 for the existence of a publisher's (M3) identification code as a file name, as a tag, or embedded in the image. A negative result causes the routine to branch at to image tag entry step 320 with the result that on the completed and displayed web page, rolling the pointer over that image and right clicking to display a purchase menu has no effect. This arrangement has the advantage for the image originator of backward compatibility with his existing thumbnail or other low resolution images and existing web pages. A new web page can be created with a combination of old images and images with a publisher's identifier, and page creation and handling by the web browser requires only minimal disturbance to existing procedures and software. If the check at 314 proves positive, the routine branches to step 316 where a check is made for the existence in the web page of a tag for redirection to the IPS. On a positive result, the routine branches at 317 to image tag entry step 320, and on a negative result it branches to tag entry step 318 for redirecting the client station to the IPS and downloading the necessary file or files and data from software 32 of the IDP. Completion of step 320 signifies that an image tag has been entered into the HTML document, the image optionally being present as part of a Flash movie, the image has been checked for a publisher's identity for the image, and a check has been made that any necessary redirection instructions are present on the web page. The routine passes to page completion step 322 the result of which is normally entered manually. A negative entry brings about a branch at step 223 to step 310 and permits entry of a new image, and a positive entry brings about a branch to a completed web page storage step 324. The web page creation routine is shown operating at remote website WSₙ, but the same routine could operate at websites WSₘ (both m and n are arbitrary integers) that are not image origination sites but are sites where it is desired to make available web pages incorporating thumbnails or other low resolution images distributed by the IPS. The web page creation routine may also operate at the IPS for making image-containing web pages available at the IPS.

Various modifications may, of course, be made to the embodiment described above without departing from the invention. Where the images are presented electronically it may be preferable to embed the identification numbers in the files of the displayed images. As previously explained by suitable construction of the files a facility could be provided e.g. where a “right click” of a mouse revealed an option to order a reproduction of the displayed image. Selection of a “buy” option revealed by “right clicking” on the displayed image would instruct the local computer apparatus to connect with a website of the product supplier. During the connection the identifier of the selected image would be transferred to the product supplier so that the relevant image could be located and accessed. The image stored by the supplier would typically be a higher resolution version of the image initially viewed by the consumer. The website would allow the consumer to select a product on which the higher resolution image would be reproduced.

In a variation of the above, a version of image display software could be issued with a button bar facility to “buy”. Such a facility could be provided e.g. in Microsoft® Photoshop or Corel® Draw. Selecting the “buy” button would direct the local computer running the software to connect with a website of the product supplier. During connection identification information embedded in the displayed image file would be relayed to product supplier and thus a high resolution version of the displayed image could be accessed and made available for reproduction on a product selected by the consumer from the website. Alternatively, a “buy” or “buy as” option could be included in the standard “File” menu in the Windows or Apple operating systems and related applications software. The option would appear, e.g., alongside the “save as” option in the “File” menu or other similar menu. The “buy” option would become part of the underlying operating system software.

According to the above variation, an online low resolution image, placed by a web designer on any site from the stock images available, is internally “connected” to the product supplier's website. The user simply selects the image, and is automatically redirected to the appropriate page on the website, selects the object on which the image is to be rendered, and makes payment. In order to achieve this, the consumers may be provided with a browser plug-in that will:

1. Display a low-resolution version of the specified image

2. Allow the consumer to select the image for rendering

3. Redirect the consumer to the appropriate page on the IPS website.

The plug-in should operate on as many platforms as possible (Macintosh, Windows, Linux; Internet Explorer, Netscape Communicator, Opera) and as seamlessly as possible. The plug-in will also enable the designer to easily select and place images on the page. Each high resolution image will be processed to create a low-resolution version of the data which is encoded with an unique identification number, plus other data. This low-resolution image format can then be delivered to the plug-in for processing. The plug-in should be capable of displaying a low resolution image directly on the page.

In order to achieve the best, most seamless results, it is proposed that a new MIME file type is adopted for the image. Thus there will be:

1. A formal specification of the file type

2. Registration of the MIME Type with the IETF (see RFC2048) as a Vendor specific MIME type

3. Registration of a currently unused file extension.

It is proposed that the file format is a new file type and not a new file encoding. As such, it should support all current file encoding, and delegate all image processing functionality to existing MIME types. For example, the encoding of a JPEG image inside an M3 file should be delegated to the registered JPEG image processor.

The new File Format used for the images may use the standard chunk format used by many existing file encoding. The header format is as follows:

Magic Number [bytes]

| | | |
|---|---|---|
| VERS [4 bytes] | Size [4 bytes] | Version [4 bytes] |
| UIRN [4 bytes] | Size [4 bytes] | Unique Image Reference |
| | | Number [bytes] |
| URLR [4 bytes] | Size [4 bytes] | NRL Reference [n bytes] |
| CKSM [4 bytes] | Size [4 bytes] | MD5 checksum [16 bytes] |
| IMGT [4 bytes] | Size [4 bytes] | Image Type [n bytes] |
| DATA [4 bytes] | Size [4 bytes] | Data [n bytes] |

VERS contains the version of the file. The version will contain 4 bytes: the first two bytes the major version number and the last two bytes the minor version number.

IURN contains the Unique Image Reference Number.

URLR contains the URL reference for this image. This UR points to where a clock on the image will send the user.

CKSM contains an MD5 digest of the image and header data. This is used to confirm that the file has not been tampered with en route or modified without knowledge.

IMGT contains the image MIME type. This is used to delegate the processing of the image to the correct codec.

DATA contains the image data.

Data need not be encrypted. The additional data in the header is used by the appropriate plug-in to process the user interaction with the image. The raw data can be then be processed normally, and displayed.

In a further variant, to facilitate issuance of identifiers to images digital cameras and/or software associated therewith could be provided with a facility to assign an identifier to each recorded image. The issued identifiers could be periodically uploaded to the IPS. In this method it is not the IPS which issues the unique identifiers for the images, but the digital camera and/or associated software, these having been programmed to issue identifiers in a correct format. The digital camera or related software could have a unique copyright holder identification number pre-programmed so that any image recorded by the camera or the related software would have embedded in the image file the copyright holder identification number. Such a number could be an identification number .for a copyright holder rather than to a copyright work.

A publisher's (M3) image identifier may be embedded into a JPEG image file, which provides tangible added value to an existing image document because embedding alleviates the need to add an M3 reference tag manually or to rename an image to facilitate identification. The publisher's (M3) reference may consist of a signature, reference and checksum. The signature may be the name (e.g. MMM3) of the IDP software 32. The reference can be any Unicode characters in sequence and the checksum may be a check of e.g. file name (MMM3)+reference. The M3 identifier may be embedded into the JPEG image as a JPEG_APP1 marker. The JavaScript parser will open the file and walk down the chumk list until it encounters a JPEG_APP1 marker, will extract the marker data, check that the signature begins with the predetermined sequence (e.g. MMM3) and if so will retrieve the reference. It will then perform a checksum on the MM3 and the reference to ensure that the data is not corrupt, and will return the reference, after which the existing code menu can use the reference as normal.

A computer program product is provided for use in the creation of a production file of an image for application to a custom imprinted article e.g. a mobile phone, mug or T-shirt. The product comprising instructions for displaying at least one web page, down-loading an image which may be a proxy for a full resolution image, displaying the image in a rendering area of said web page, displaying in said web page controls for input of rendering instructions, locally processing the displayed image in accordance with the rendering instructions, and up-loading of the rendering instructions on completion of rendering. The image display instructions provide for displaying a mask in a mask layer and for displaying at least one editable or renderable image in an image layer that underlies the mask layer and appears only through the mask. The images for use with the computer program product including thumbnail images, preview images, proxy images and full resolution images are advantageously provided with a unique identifier within a naming convention established at an image publishing site.

It will be appreciated that while the above description addresses use of the present invention over the Internet, the present invention is adaptable to global computer networks, LAN, WAN and other electronic networks.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of the present invention. For example, although described in object-oriented terms, one of ordinary skill in the art will appreciate that the invention can be implemented in a procedural design environment or any other design environment that provides the required relationships.

In particular, one of skill in the art will readily appreciate that the names of the methods and apparatus are not intended to limit embodiments of the invention. Furthermore, additional methods and apparatus can be added to the components, functions can be rearranged among the components, and new components to correspond to future enhancements and physical devices used in embodiments of the invention can be introduced without departing from the scope of embodiments of the invention. One of skill in the art will readily recognize that embodiments of the invention are applicable to future communication devices, different file systems, and new data types.

The terminology used in this application with respect to is meant to include all object-oriented, database and communication environments and alternate technologies that provide the same functionality as described herein. Therefore, it is manifestly intended that this invention be limited only by the following claims and equivalents thereof.

1. A computer program product for use in the creation of a production file of an image for application to a custom imprinted article,
said product comprising instructions for displaying at least one web page, down-loading an image, displaying the image in a rendering area of said web page, displaying in said web page controls for input of rendering instructions, locally processing the displayed image in accordance with the rendering instructions, and up-loading of the rendering instructions on completion of rendering,
wherein said image display instructions provide for displaying a mask in a mask layer and for displaying at least one renderable image in an image layer that underlies the mask layer and appears only through the mask.

2. The product of claim 1, wherein the instructions provide for downloading a mask for entry into the mask layer, said mask corresponding to a product identifier.

3. The product of claim 2, wherein the instructions provide for display of a product selection menu and up-loading of an identifier for a selected product.

4. The product of claim 2, wherein the instructions provide for downloading a mask corresponding to an identifier up-loaded on selection of a product on a selection menu of a web page preceding said at least one page.

5. The product of claim 2, wherein the mask has an outline which is an image of the product.

6. The product of claim 2, wherein the mask has an outline within an outline of the product.

7. The product of claim 6, further comprising instructions for down-loading into at least one auxiliary layer an image of the product through which the mask is viewable, said auxiliary layer or layers overlying the mask layer.

8. The product of claim 6, wherein the auxiliary layers comprise a first auxiliary layer for receiving a downloaded image of the product, a second auxiliary layer for receiving at least one image of at least one variable region of the product that underlies and appears through the first layer, and wherein instructions are provided for displaying controls for modifying said variable region or regions.

9. The product of claim 8, wherein said controls are operable to change the color of the variable region or regions.

10. The product of claim 1, wherein the instructions provide for display in said web at least one web page of at least one control for switching between a first state for entry of local image information and for rendering images entered locally into a first layer and a second state for rendering the down-loaded image in a second layer.

11. The product of claim 10, wherein the instructions provide for display on said at least one web page in said first state of a local information entry area and loading into the first layer of information entered in said area.

12. The product of claim 1, wherein the renderable image in the image layer is a raster graphics image.

13. The product of claim 12, wherein the renderable image is a JPEG image.

14. The product of claim 1, further comprising instructions for down-loading the renderable image as a non-editable file compiled for viewing in a player.

15. The product of claim 14, wherein the non-editable file is a .swf Flash Player file.

16. The product of claim 1 wherein said at least one web page displays, or is linked to a page displaying, a control linking to one or more pages that permits or permit an image to be up-loaded for rendering and use in the creation of the production file.

17. The product of claim 1 wherein said at least one web page displays, or is linked to a page displaying, a control linking to one or more pages that provide links to one or more browsable galleries each providing one or more pages of images and that contain instructions permitting selection of an image for rendering and use in the creation of the production file.

18. The product of claim 1, wherein the pages of images contain instructions for checking the presence of an identifier when a pointer is over the image and on entry of a right click at a pointing device providing an indication whether the image is available for rendering and creation of a production file.

19. The product of claim 1 wherein said at least one web page displays, or is linked to a page displaying, a control linking to one or more pages that permits or permit an image to selected for rendering and use in the creation of the production file on entry of an identifier.

20. Apparatus for use in the creation of a production file of an image for application to a custom imprinted article, comprising:
a web server loaded with a computer program product comprising instructions for displaying at least one web page, down-loading an image, displaying the image in a rendering area of said web page, displaying in said web page controls for input of rendering instructions, locally processing the displayed image in accordance with the rendering instructions, and up-loading of the rendering instructions on completion of rendering wherein said image display instructions provide for displaying a mask in a mask layer and for displaying at least one renderable image in an image layer that underlies the mask layer and appears only through the mask; and
means for supplying a rendered image to a printing station.

21. The apparatus of claim 20, wherein the web server provides access to full resolution images and linked lower resolution proxy images and the computer program product contains instructions for downloading a proxy image for display in the image layer and for printing an image at the production station using the full resolution image and up-loaded rendering instructions.

22. A method for producing an article having an image applied thereto, which comprises:
storing a full resolution image and a linked proxy image of lower resolution;
downloading from a web server to a client station a web page loaded with the proxy image;
displaying the proxy image in a rendering area of said web page together with controls for input of rendering instructions, said image comprising a mask in a mask layer and at least one renderable image in at least one renderable image layer that underlies the mask layer and appears only through the mask, at least one layer having the proxy image;
locally processing the displayed image in accordance with the rendering instructions;
up-loading of the rendering instructions on completion of rendering; and
printing the resulting rendered image at a printing station on or for application to the article in accordance with the rendering instructions and the full resolution image.

23. Apparatus for creating an image production file from data for a high resolution image by remote selection of an image generated using a lower resolution proxy image, said apparatus comprising:
at least one image data storage device accessible to a network for retrievably storing images as full resolution graphics files;
an image publishing site on the network provided with a store for storing a unique identifier for each stored image within a naming convention that is common to the images together with the address of the full resolution graphics file for said image, and also provided with an image data processing program;
one or more websites on the network at locations other than that of the image publishing site for making available at least one web page including at least one proxy image stored by said at least one image data storage device, formed with reduced size or low resolution image data and associated with the unique identifier for that image, the web page having means responsive to selection of the or each proxy image for which an identifier is present to enable input of an image processing command and supply of the network location of the image publishing site and the path to and name of the image data processing program; and
one or more client stations on the network remote from the or each image storage means and from the image publishing site and arranged to permit entry of an image processing command for an image having a unique identifier within the naming convention and contained in a web page received from said one or more websites, and to submit the identifier and the command to the image publishing site so as to cause image data in the high resolution graphics file to be processed at the publishing site with the processing program to create an image production file for delivery to image application means.

24. The apparatus of claim 23, wherein an image data storage device forms part of the image publishing site.

25. The apparatus of claim 23, wherein an image data storage device forms part of a website on the network, and the image data processing program includes instructions for uploading a full resolution graphics file from the image data storage device to the image publishing site on receipt from the client station of the identifier for that file and the image processing command.

26. The apparatus of claim 23, wherein the image data storage device is arranged to store images as JPEG files.

27. The apparatus of claim 23, wherein the image data storage device is arranged to store images as bitmaps, and the image data processing program includes instructions for converting a bitmap file to a JPEG file.

28. The apparatus of any preceding claim, wherein the image data processing program contains instructions, on receipt of a command that a high resolution graphics file for an image is to be made available, to create at least a proxy file for the image with low resolution or reduced size data, to allocate a unique identity to the high resolution and to the proxy file, and to include the unique identity within the proxy file.

29. The apparatus of claim 28, wherein the image data processing program contains instructions for storage of the proxy file.

30. The apparatus of claim 28, wherein the image data processing program contains instructions for downloading the proxy file for the image to one or more websites on the network for incorporation into web pages.

31. The apparatus of claim 28, wherein the image data processing program contains instructions for additionally creating a thumbnail image.

32. The apparatus of claim 23, wherein the image data processing program further comprises instructions for processing the image data from the full resolution graphics file in response to variables entered at the client station and creating an image production file that contains data for a rendered version of the image.

33. The apparatus of claim 32, wherein the image data processing program includes instructions for creating and downloading to the client station a renderable proxy image data file, a viewer forming part of a web browser program resident at the client station permitting the proxy image to be rendered with geometrical data entered at the client station, and instructions forming part of the web page enabling the image identifier and the rendering data to be uploaded to the image publishing site.

34. The apparatus of claim 33, wherein the image data processing program includes instructions for creating a renderable image file having at least first and second data layers, the first layer being arranged to receive the renderable image data, and the second layer providing a mask through which portions of the renderable image are displayable and that defines an outline for the rendered image.

35. The apparatus of claim 34, wherein the image data processing program includes instructions for storing bit map or JPEG data in the first layer.

36. The apparatus of claim 34, wherein the image data processing program includes instructions for storing the mask in the second layer as vector graphics.

37. The apparatus of claim 34, wherein the image data processing program includes instructions for providing a third layer for data for scaleable font characters.

38. The apparatus of claim 34, wherein the image data processing program includes instructions for entering geometrical data selected from the group consisting of X-Y position of the image relative to the mask, angular position of the image relative to the mask, size of the image relative to the mask and image inversion.

39. A method for producing an image production file from data for a high resolution image by remote selection using an image generated using low resolution or reduced size data, said method comprising:
storing images as high or full resolution graphics files in at least one data storage device accessible to a network;
storing in memory of an image publishing site on the network a unique identifier for each stored image within a naming convention that is common to the images together with the address of the high resolution graphics file for said image, and providing at the image publishing site an image processing program;
providing at websites on the network at locations other than that of the image publishing site web pages including at least one image stored by said at least one image data storage device, formed with reduced size or low resolution image data and associated with the unique identifier for that image;
downloading a web page including at least one said image from one of the websites to a client station on the network remote from the or each image storage means and from the image publishing site and displaying the web page at said client station;
selecting at the client station said image on the displayed web page and entering a processing command that is available if the selected image has an associated unique identifier within the naming convention;
uploading to the image publishing site using an image publishing site location record within the web page the identifier and the command and loading the image processing program using a path and name record within the web page for the image processing program;
extracting from the data storage device data for the high resolution graphics corresponding to the identifier and processing said data at the image publishing site with the processing program to give the image production file for delivery to image application means.

40. A computer program product containing instructions for carrying out the method of claim 39.

41. A method of forming an image on a substrate which comprises creating an image production file using the apparatus of claim 23, supplying the image production file to a printer and printing the image contained in said file on a substrate.

42. The method of claim 41, wherein said image is a rendered image.

43. A digital data file for use with the apparatus of claim 23, comprising data defining an image at low size or resolution for publication on a web page at a first URL, an identifier for the image, and means providing a link to an image processing program at a second URL with access to a file comprising data defining the image at higher size or resolution.

44. The file of claim 43, wherein the identifier is provided as a reference in an image tag.

45. The file of claim 43, wherein the identifier is provided as a file name in an image tag.

46. The file of claim 43, wherein the identifier is embedded in the image.

47. The file of claim 43 which is an HTML document.

48. The file of claim 47, wherein the image is present within a non-editable Flash movie file.

49. A computer program product for downloading from an image publishing station at a client station and display on a web page of at least one image, a unique identifier within a naming convention being associatable with the image, instructions being provided for testing for the presence of the unique identifier on display of the image and on coincidence of a mouse pointer with the image, and instructions being provided for image reproduction on right clicking the mouse if a unique identifier is associated with the image overlaid by the pointer.

50. The product of claim 49, including instructions for display of a gallery page having an array of selectable thumbnail or preview images.

51. The product of claim 49, further comprising instructions for display on right clicking the mouse of a menu of products on which the image can be applied.

52. The product of claim 49, further comprising instructions on right clicking the mouse to display an image editing or rendering page with the selected image.
